(19) United States
(12) Patent Application Publication
(10) Pub. No.: US 2017/0074748 A1
(43) Pub. Date: Mar. 16, 2017

(54) Normalized Hydrostatic Test Method

(71) Applicant: Engip LLC, Houston, TX (US)

(72) Inventors: Clifford Lee Hilpert, Conroe, TX (US); Lewis Jackson Dutel, Houston, TX (US); Laura Tufts Meyer, Sealy, TX (US); Jeffery Hilpert, Conroe, TX (US); David William Blacklaw, Houston, TX (US)

(73) Assignee: Engip LLC, Houston, TX (US)

(21) Appl. No.: 15/360,861

(22) Filed: Nov. 23, 2016

Related U.S. Application Data
(63) Continuation-in-part of application No. 15/201,090, filed on Jul. 1, 2016.
Application No. 15/201,090 is a continuation-in-part of application No. 15/151,323, filed on May 10, 2016.
Application No. 15/151,323 is a continuation-in-part of application No. 14/932,727, filed on Nov. 4, 2015.
(60) Provisional application No. 62/191,419, filed on Jul. 12, 2015.
(60) Provisional application No. 62/159,429, filed on May 11, 2015.
(60) Provisional application No. 62/140,795, filed on Mar. 31, 2015.

(51) Int. Cl. G01M 3/28; E21B 33/06

(52) U.S. Cl. CPC G01M 3/2876; E21B 33/06

(57) ABSTRACT

Blowout preventers, fluid pressure systems and portions thereof may be tested for leaks utilizing either a pressure decay rate method test or a volumetric leak rate method test of a hydrostatic pressure. The method provides for a means of resolving the nonlinear relationship between volumetric loss and test pressure utilizing either a pressure decay rate method test or a volumetric leak rate method test of a hydrostatic pressure test into a single dimensionless number that approximates the diameter of an orifice.

### CROSS-REFERENCE TO RELATED APPLICATIONS

This application claims priority to and is a continuation in part of U.S. application Ser. No. 15/201,090 filed Jul. 7, 2016 which claims priority to U.S. provisional application 62/191,419 filed Jul. 12, 2015. This application is also a continuation in part of U.S. application Ser. No. 15/151,323 filed May 10, 2016 which claims priority to U.S. provisional application 62/159,429 filed May 11, 2015. This application is also a continuation in part of application Ser. No. 14/932,727 filed Nov. 4, 2015 which claims priority to U.S. provisional application 62/140,795 filed Mar. 31, 2015.

The entire contents of the above identified provisional and non-provisional U.S. patent applications are expressly incorporated herein by reference thereto.

### BACKGROUND OF THE INVENTION

a) Field of the Invention

This application is directed to a method of testing a closed hydraulic system for example a blowout preventer (BOP) assembly for leaks. Oil and Gas Exploration risk management includes the ability to control subsurface pressure which may be encountered during drilling operation. The primary mechanism utilized by operators to control downhole pressure is the hydrostatic pressure as a result of the drilling fluid contained within the wellbore. The drilling fluid is engineered and formulated to a density that provides a hydrostatic pressure inside of the wellbore that is greater than the formation pressure being drilled. In the majority of drilling operations, the hydrostatic control is adequate. However, from time-to-time the operator may encounter a higher than expected formation pressure where there is not adequate hydrostatic pressure to control the wellbore pressure. During these times the operator relies on a series of mechanical controls to stabilize the wellbore and prevent a “Blow Out.” A blow out is the uncontrolled release of fluid or gas from the wellbore. This event is extremely dangerous and therefore must be avoided if at all possible. The primary mechanical control device utilized by operators to control wellbore pressure is the Blowout Preventer (BOP) assembly. The BOP assembly consists of valves, and multiple sealing and shearing devices that are hydraulically actuated to provide various means of sealing around the drill string or shearing it off entirely, completely sealing the wellbore. It is essential that the BOP assembly operate as designed during these critical operations. Therefore, it is a regulatory requirement to test the functionality and the integrity of the BOP assembly before starting drilling operations and at specific events during the drilling operations. An additional goal of these tests are to identify reliability trends specifically related to leak rates. It is perceived that BOP assemblies with leak rates having an increasing trend are more likely to fail in a critical well control event. As will be disclosed within this disclosure, the forgoing perception is only true if the leak rate is normalized to a single value that normalizes the effects of pressure and compressibility.

b) Description of Related Arts Invention

The BOP assembly test is a series of pressure tests at a minimum of two pressure levels, low pressure and high pressure. During the pressure test, fluid from a high pressure pump unit is introduced into the closed BOP assembly in a volume sufficient to cause the internal pressure within the closed BOP assembly to rise to the first pressure test level. Once the first pressure test level is established the high pressure pump system is isolated from the closed BOP assembly and the pressure is monitored, utilizing electronic or mechanical chart recorders, for a specified time period. During the monitoring phase the pressure decay is determined and compared to the pressure decay specification. A typical specification for compliance allows for a pressure decay rate of no more than 5 psi/minute or 25 psi total over the entirety of the five-minute test. Measuring leak rate utilizing the indirect result of pressure decay, while widely accepted, is problematic and not indicative of a specific leak rate. Such factors as the compressibility, volume of the required intensification fluid, the amount of trapped air within the BOP assembly, and the flexibility of the BOP assembly have an effect on the relationship between the pressure decay rate and the actual leak rate. An example related to trapped air: if a typical land-based BOP assembly having an approximate test volume of 15 gallons and a volumetric loss rate of approximately 25 cc/min @250 psi is tested at 250 psi with approximately 7.5 gallons of air trapped within the BOP assembly during the monitoring phase of the hydrostatic test and then subsequently tested with approximately 2.5 gallons of air trapped within the BOP assembly during the monitoring phase of the hydrostatic test, the BOP would pass the first test with approximately a 3.2 psi/min pressure decay rate but, it would fail the second test with a 7.4 psi/min pressure decay rate. Each test would have the same volumetric loss rate of 25 cc/min but the result of the tests would be significantly different. In another example related to compressibility: if a typically BOP assembly, having 5 gallons of trapped air within the BOP assembly, and rig up configuration requiring approximately 50 gallons of a typical test fluid to conduct a high pressure (5000 psi) pressure decay test is first tested with a volumetric loss rate of approximately 3 cc/min, the resultant approximate psi/min decay rate will be 6.0 psi/min and the test would fail. If the same high pressure (5000 psi) pressure decay test is applied to the same typical BOP assembly but the rig up configuration requires approximately 100 gallons of a typical test fluid to conduct a high pressure (5000 psi) pressure decay test is first tested with a volumetric loss rate of approximately 3 cc/min, the resultant approximate psi/min decay rate will be 3.0 psi/min and the test would pass. Each test would have the same volumetric loss rate but the result of the tests would be significantly different. An additional example related to compressibility: if a typically BOP assembly, having 5 gallons of trapped air within the BOP assembly, and rig up configuration requiring approximately 50 gallons of a typical test fluid to conduct a high pressure (5000 psi) pressure decay test and the test results indicated a 3 psi/min pressure decay, the volumetric loss rate will be 1.5 cc/min. If the same high pressure (5000 psi) pressure decay test is applied to the same typical BOP assembly but the rig up configuration requires approximately 100 gallons of a typical test fluid to conduct a high pressure (5000 psi) pressure decay test and the test results indicated a 3 psi/min pressure decay, the volumetric loss rate will be 3.0 cc/min. Each test would have the same pressure psi/min decay rate and pass, but the volumetric loss rate would be significantly different. As is apparent, utilizing either the decay rate or the volumetric loss rate will not provide a means of comparing tests performed on the same or different BOP assembly at different compressibility factors and/or different pressures levels.

It would be much more desirable to utilize a new and unique test method that normalizes the results of either the pressure decay rate test method or the volumetric loss rate test method to a single value which can be directly compared without regards to the variables of compressibility and/or test pressure. Thus there remains a need for a hydrostatic test method that provides normalized results depicted in a single value which can be utilized as an indicator of BOP assembly integrity and can be directly compared to historical data without regards to the variables of compressibility and/or test pressure. This would allow for meaningful reliability statistics as well as a more uniform measurement of BOP assembly integrity.

### BRIEF SUMMARY OF THE INVENTION

The following detailed description of the improved hydrostatic test method is intended as an exemplification of the principals of the invention and not intended to limit the invention to any specific embodiment. The improved hydrostatic test method provides for a means of resolving the nonlinear relationship between volumetric loss and test pressure utilizing either a pressure decay rate method test or a volumetric leak rate method test of a hydrostatic pressure test into a single dimensionless number that approximates the diameter of an orifice.

There are two distinctly different methods of detecting a leak within a BOP assembly. The most common method is a constant volume, variable pressure test. In this test a fixed amount of intensification fluid is added to the BOP Assembly. The initial test pressure is recorded and compared to the subsequent pressure at a corresponding subsequent time. The difference between the initial and subsequent pressure, if any, is calculated. This test is usually expressed in units of psi/min. A lesser utilized method is constant pressure, variable volume. In this test the amount of intensification fluid required to maintain the test pressure over a period of time is measured. The test is usually expressed in units of cc/min. As will be explained in more detail below, either of these tests can be utilized to resolve the nonlinear relationship between volumetric loss and test pressure into a single dimensionless number that approximates the diameter of an orifice.

### BRIEF DESCRIPTION OF SEVERAL VIEWS OF THE DRAWINGS

For a detailed description of the preferred embodiments of the invention, reference will now be made to the accompanying drawings in which:

FIG. 1 is a graph depicting a typical test cycle.

FIG. 2 is a diagram of apparatus suitable for carrying out an embodiment of the invention.

### DETAILED DESCRIPTION OF THE INVENTION

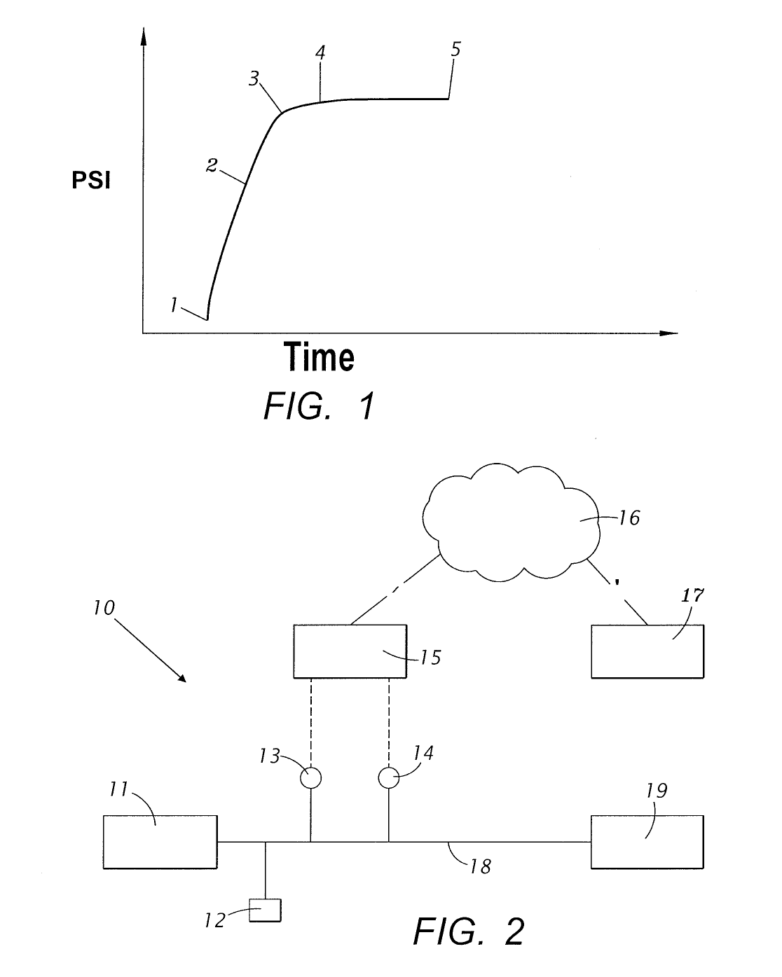

FIG. 1 illustrates a typical test cycle of the two different embodiments. First describing the constant pressure, variable volume test method. The pressure in the BOP or system 19 which may contain trapped air is raised from point 1 to point 4 as shown in FIG. 1. Point 4 represents the test pressure level. As the test pressure increases from point 3 to point 4, the incremental pressure change of the intensifying pressure is measured by a pressure sensor 13 and the incremental volume change of intensifying fluid is also monitored by a volume meter 14 positioned in flow conduit 18 which leads to BOP or system 19. During a typical test cycle an isolated area of the BOP which may include valves and safety devices is pressurized and volume rates and pressure of the intensifying fluid are recorded by the sensors 13 and 14. Thus information is sent to a computer processor 15.

The Apparent Compressibility Factor ACF is calculated by the following formula.

Va/PSI=ACF

Where Va=Incremental volume change of intensifying fluid, PSI=Incremental pressure change of the intensification pressure (psi), and ACF=Apparent Compressibility Factor. The Apparent Compressibility Factor is representative of the relationship between an incremental change of intensification fluid and the resultant incremental change in pressure. It is usually expressed as cc/psi.

When the BOP or system is pressurized to the test pressure level 4, the amount of intensifying fluid added in order to maintain the test pressure is measured over time (point 4 to point 5 of FIG. 1).

The Apparent Orifice Factor (AOF) is calculated by the following formula: O=Vi/√P.

Where O=Apparent Orifice Factor, Vi=volume loss rate, and P=test pressure. The Apparent Orifice Factor dimensionless quantity representative of the nonlinear relationship between volumetric loss and test pressure expressed as a single dimensionless number that approximates the diameter of an orifice.

Now describing the constant volume, variable pressure method. The pressure in the BOP or system 19 which may contain trapped air is raised from point 1 to point 4 as shown in FIG. 1. Point 4 represents the test pressure level. As the test pressure increases from point 3 to point 4, the incremental pressure change of the intensifying pressure is measured by a pressure sensor 13 and the incremental volume change of intensifying fluid is also monitored by a volume meter 14 positioned in flow conduit 18 which leads to BOP or system 19. During a typical test cycle an isolated area of the BOP which may include valves and safety devices is pressurized and volume rates and pressure of the intensifying fluid are recorded by the sensors 13 and 14. Thus information is sent to a computer processor 15.

The Apparent Compressibility Factor ACF is calculated by the following formula.

Va/PSIA=ACF

Where Va=Incremental volume change of intensifying fluid, PSIA=Incremental pressure change of the intensification pressure (psia), and ACF=Apparent Compressibility Factor.

When the BOP or system is pressurized to the test pressure level 4, the amount of intensification fluid is held constant and the resultant pressure decrease or increase is measured over time (point 4 to point 5 of FIG. 1).

With this information, the equivalent volume change can be calculated by the following formula: Vi=Pd/ACF. Where ACF=Apparent Compressibility Factor, Vi=volume loss rate, and Pd=measured equivalent decay rate in psi/minute.

With this information, the Apparent Orifice Factor (AOF) can be calculated by the following formula: O=Vi/√P. Where O=Apparent Orifice Factor, Vi=volume loss rate, and P=test pressure.

Referring to FIG. 2, apparatus for carrying out an embodiment of the invention may include a computer processor 15 connected wirelessly or via hard wires to, and in electrical communication with, pressure sensor 13, and volume meter 14. Additionally, pressure sensor 13 and volume meter 14 are in fluid communication with BOP assembly 19 subject to the hydrostatic leak test. Sensor data from pressure sensor 13 and volume meter 14 is collected at a deterministic frequency to ensure time series data collection. During a typical BOP assembly hydrostatic test intensification pump 11 is placed in fluid communication with BOP assembly 19 via high pressure intensification line 18. Pressure sensor 13 and volume meter 14 may be integrated into one apparatus or may be configured separately. Both pressure sensor 13 and volume meter 14 are placed in fluid communication with BOP assembly 19 and are connected to computer processor 15. It is desirable for pressure sensor 13 to be placed in fluid communication with BOP assembly 19 as close as practical to BOP assembly 19. Additionally, volume meter 14 and pressure sensor 13 are placed in electrical communication with computer processor 15. Chart recorder 12 is in fluid communication with BOP assembly 19. Computer processor 15 includes a computer program and a means of interacting with the computer program such as a keyboard, mouse or touch screen. The technician enters relevant information and process variables into the computer program of computer processor 15 pertaining to the immediately forthcoming hydrostatic test including the variable describing the hydrostatic intensification level (pressure level). The computer program can be initiated by the technician or automatically initiated when volume meter 14 senses flow of the intensification fluid. As the hydrostatic test is initiated and subsequently the intensification level reaches the intensification level previously specified by the technician, computer processor 15 samples both the pressure sensor 13 and the flow meter 14 within approximately the same deterministic time series. The just sampled values from pressure sensor 13 and volume 14 are processed by the computer program of computer processor to solve for the apparent compressibility factor by: Va/PSIA=ACF. Subsequently the computer program of computer processor 15 would utilize the just solved ACF number to calculate the apparent orifice number utilizing the measured leak rate or pressure change depending on the test method. Computer processor 15 and the computer program can also be utilized to store a time stamped log of the entire test for off-site analysis and as a backup to chart record 12. Additionally, computer processor 15 can be in communication with offsite location 17 via internet, radio, cellular, and or other suitable information dissemination network 16.

The following are two hypothetical tests of pressure testing and normalizing the results of a blowout preventer portion according to an embodiment of the invention.

For the purpose of the first test, the test method utilized is constant pressure, variable volume and the test pressure is 3775 psi. It takes approximately 16.5 gallons of intensifying fluid from pump 11 to reach the test level pressure. This takes about 4 minutes. Beginning at a pressure slightly lower than the test pressure (point 3 in FIG. 1) for example at 3675 psi, the amount of fluid required to make a 1 psi change in pressure is calculated by the computer based upon the incremental volume change of the fluid and the incremental change of the intensification pressure which is measured by volume meter 14 and pressure sensor 13 respectfully.

In this test, assume that the apparent compressibility factor was determined to be 10.79 cc/psi. This part of the test could take as little as one second.

Immediately after reaching the test pressure (point 4 of FIG. 1), the amount of added intensification fluid/min required to maintain a constant test pressure at 3775 psi is measured. This part of the test lasts for approximately 2 minutes (point 4 to point 5 of FIG. 1).

In this example, assume that the measured amount of fluid added per minute to maintain the constant test pressure is 92.2 cc/min.

Therefore the Apparent Orifice Factor (AFO) O=Vi/√P would be 92.2/\sqrt{3775}=1.5 Also note that the calculated equivalent decay rate (Pd) for this test is 8.5 psi/min.

For the purpose of the second test, the test method utilized is constant pressure, variable volume and the test pressure is 5750 psi. It takes approximately 38.8 gallons of intensifying fluid from pump 11 to reach the test level pressure. This takes about 8 minutes. Beginning at a pressure slightly lower than the test pressure (point 3 in FIG. 1) for example at 5650 psi, the amount of fluid required to make a 1 psi change in pressure is calculated by the computer based upon the incremental volume change of the fluid and the incremental change of the intensification pressure which is measured by volume meter 14 and pressure sensor 13 respectfully.

In this test, assume that the apparent compressibility factor was determined to be 19.8 cc/psi. This part of the test could take as little as one second.

Immediately after reaching the test pressure (point 4 of FIG. 1), the amount of added intensification fluid/min required to maintain a constant test pressure at 5750 psi is measured. This part of the test lasts for approximately 2 minutes (point 4 to point 5 of FIG. 1).

In this example, assume that the measured amount of fluid added per minute to maintain the constant test pressure is 113.7 cc/min.

Therefore the Apparent Orifice Factor (AFO) O=Vi/√P would be 113.7/\sqrt{5750}=1.5. Also note that the calculated equivalent decay rate (Pd) for this test is 5.7 psi/min.

In the above examples the leak rate (Vi) and the equivalent pressure decay rate (Pd) are significantly different, however the Apparent Orifice Factor is the same and much more indicative of the physical condition of the BOP assembly. In the examples above related to the leak rate (Vi): the leak rate (Vi) indicated in the first and second tests are 92.2 and 113.7 cc/min respectively. This would indicate that the leak path within the BOP Assembly, from which the pressurized fluid is escaping, had increased in area and therefore resulting in an increased leak rate, from 92.2 cc/min to 113.7 cc/min. In an examples above related to pressure decay rate (Pd): the pressure decay rate (Pd) indicated in the first and second tests are 8.5 and 5.7 psi/min respectively. Converse to the previous example of leak rate indication, the pressure decay rate indicates a reduction in the leak path area from which the pressurized fluid is escaping, therefore resulting in a reduction of the pressure decay rate from 8.5 to 5.7 psi/min. However, if the two tests are normalized according to the embodiment of the invention it is discovered that the Apparent Orifice Factor has remained unchanged at 1.5 for each test one and test two. This indicates that the leak path area has remained unchanged and the integrity of the BOP Assembly remains unchanged. It is evident by the examples above that the Apparent Orifice Factor can be utilized to normalize and subsequently compare BOP assembly test results across various BOP assembly test pressures and BOP assembly test volumes.

The apparatus utilized to measure the volume of intensifying fluid added to increase the pressure a specified amount may be a simple totalizing flow meter, a stroke counter of a reciprocating pump, or something more precise such as a precision displacement measuring cylinder. The intensifying pump may be any suitable intensification pump including rotary and reciprocating positive displacement pumps. The pressure may be measured with a precision digital or analog pressure sensor or other suitable means that will provided the required precision and resolution. A typical computer, PDA, tablet, industrial processor, or any other device capable of performing basic logic and arithmetic functions could receive the volume and pressure information from the pressure and volume sensors to calculate the Apparent Compressibility Factor

Although the present invention and its advantages have been described in detail, it should be understood that various changes, substitutions and alterations may be made herein without departing from the spirit and scope of the invention as defined by the appended claims.

1. A method of pressure testing a fluid system for leaks at a specified test pressure comprising;
a) pressurizing the system to the test pressure by introducing pressure intensifying fluid under pressure into the system,
b) measuring for a finite time period the amount of added intensifying fluid required to maintain the system at the specified test pressure, and
c) determining the resultant apparent orifice factor.

2. The method according to claim 1 wherein the apparent orifice factor is determined by the following formula
O=Vi/√P
where O=apparent orifice factor, Vi=volume loss rate, and P=test pressure.

3. The method of claim 1 wherein the fluid system is a blowout preventer for an oil/gas well.

4. A method of pressure testing a fluid system for leaks at a specified test pressure comprising;
a) pressurizing the system to the test pressure by introducing pressure intensifying fluid under pressure into the system,
b) determining the apparent compressibility factor of the system,
c) measuring the pressure decay rate of the system,
d) determining the leak rate by dividing the apparent compressibility factor by the pressure decay rate,
e) calculating the apparent orifice factor.

5. The method according to claim 4 wherein the apparent compressibility factor is determined by the following formula
Va/PSIA=ACF
where Va=Incremental volume change of intensifying fluid, PSIA=incremental pressure change of the intensification pressure (psia), and ACF=apparent compressibility factor.
